(19) United States
(12) Patent Application Publication
(10) Pub. No.: US 2025/0316018 A1
(43) Pub. Date: Oct. 9, 2025

(54) 3D REPRESENTATION OF OBJECTS BASED ON A GENERALIZED MODEL

(71) Applicant: Apple Inc., Cupertino, CA (US)

(72) Inventors: Fengqiang Li, Sunnyvale, CA (US); Chen Huang, San Jose, CA (US); Hao Tang, San Jose, CA (US); Shishir Pagad, Sunnyvale, CA (US); Thorsten Gernoth, San Francisco, CA (US)

(21) Appl. No.: 19/097,059

(22) Filed: Apr. 1, 2025

Related U.S. Application Data
(60) Provisional application No. 63/631,568, filed on Apr. 9, 2024.

(51) Int. Cl. G06T 15/20; G06T 7/55

(52) U.S. Cl. CPC G06T 15/20; G06T 7/55; G06T 2200/24; G06T 2210/12

(57) ABSTRACT

Various implementations generate a preview of a three-dimensional (3D) representation of the object. For example, an example process may include obtaining a first frame of image data of an object in a physical environment. The process may further include generating first data including data identified based on the first frame specifying one or more features identified within a plurality of 3D volumes within a 3D area. The process may further include generating a 3D representation of the object based on the first data and features from a generic model. The process may further include presenting the 3D representation of the object, where presenting the 3D representation of the object occurs prior to obtaining a second frame of image data of the object and updating the 3D representation based on the second frame.

### CROSS-REFERENCE TO RELATED APPLICATIONS

This Application claims the benefit of U.S. Provisional Application Ser. No. 63/631,568 filed Apr. 9, 2024, which is incorporated herein in its entirety.

### TECHNICAL FIELD

The present disclosure generally relates to generating three-dimensional geometric representations of physical objects, and in particular, to systems, methods, and devices that generate geometric representations of objects detected in physical environments.

### BACKGROUND

Objects in physical environments have been modeled (e.g., reconstructed) by generating three-dimensional (3D) meshes or 3D point clouds. These meshes represent 3D surface points and other surface characteristics of the physical environments' floors, walls, and other objects. Such reconstructions may be generated based on images and depth measurements of the physical environments, e.g., using RGB cameras and depth sensors. The reconstruction techniques may provide reconstructions using voxels to generate meshes. Voxels, as used herein, refer to volumetric pixels. Existing reconstruction techniques for quickly showing previews use voxels of a fixed size that are spaced in a regularly-spaced grid in 3D space without gaps in between the voxels and use sparse depth data-based modeling. For example, such reconstruction techniques may accumulate information volumetrically using truncated signed distance functions (TSDFs) that provide signed distance values for voxels within a threshold distance of a surface in the physical environment, where the values represent the distances of such voxels to the nearest respective surfaces in the physical environment. When relatively larger voxels are used by such techniques with lower resolution depth data, the techniques may fail to sufficiently represent detailed characteristics of objects, such as thin portions of objects. Accordingly, existing reconstruction techniques may fail to provide sufficiently accurate and efficient reconstructions of objects.

### SUMMARY

Various implementations disclosed herein include devices, systems, and methods that generate a three-dimensional (3D) mesh representing the 3D shape of an object in a way that is particularly useful for different/randomly shaped objects (e.g., unknown objects), and in particular to objects with thin portions or structures (e.g., a leaf, an antenna, small portions of an object protruding form a surface, and the like). For example, the system and methods described herein may provide a 3D preview (e.g., a view of a voxel model) during object scanning using a process (e.g., machine learning) that extracts 3D object geometry from color (e.g., RGB) images from different camera poses. The 3D geometry extraction from dense color image data is more accurate than using only sparse depth data-based modeling with respect to showing thin/unique structures (e.g., a leaf). In other words, the intent is to perform an on-device inference of a high quality preview (e.g., 3D point cloud or voxel) representation of an object using high resolution RGB and depth data as input into a continuous signed distance function (SDF) model (e.g., a learned continuous SDF representation of a class of shapes that enables high quality shape representation, interpolation, and completion from partial and noisy 3D input data).

In some implementations, the process/model is configured to (a) extract a 3D feature volume for each color frame and those feature volumes are fused into a 3D feature matrix that is input to a pre-trained SDF model, (b) use SDF and color values for sampling points to produce density/color values, and (c) use thresholding to extract surface data to provide the 3D preview. The process/model may be generalized in that it is trained to work on objects of different types, shapes, colors, and textures. In other words, a generalized SDF model may be trained to generate a fast 3D representation of an object (e.g., based on 1-3 frames) for an unknown-shaped object that has not been seen by a pre-trained model (e.g., a shape agnostic model).

The systems and methods described herein uses images from multiple viewpoints and camera pose information to create a voxel representation. The voxel representation may, for example, be based on 3D surface point data/point cloud data. The voxel representation is used to generate the 3D mesh. In some implementations, the process/model may use live depth data (e.g., as a prior), binary thresholding to keep or prune each voxel, and/or space carving to improve speed and efficiency.

In general, one innovative aspect of the subject matter described in this specification can be embodied in methods that include the actions of, at a device having a processor, obtaining a first frame of image data of an object in a physical environment. The method may further include generating first data including data identified based on the first frame specifying one or more features identified within a plurality of three-dimensional (3D) volumes within a 3D area. The method may further include generating a 3D representation of the object based on the first data and features from a generic model. The method may further include presenting the 3D representation of the object, where presenting the 3D representation of the object occurs prior to obtaining a second frame of image data of the object and updating the 3D representation based on the second frame (e.g., a preview).

These and other embodiments may each optionally include one or more of the following features.

In some aspects, presenting the 3D representation occurs after obtaining the first frame of image data and prior to obtaining the second frame of image data of the object. In some aspects, the first frame and the second frame are part of a single capture process.

In some aspects, generating the 3D representation of the object based on the first data and features from the generic model includes generating a 3D feature matrix based on fusing feature vectors of sampling points associated with the one or more features; determining signed distance field (SDF) values and color values associated with the sampling points associated with the one or more features, and determining density and color values for surface data of the 3D representation based on the SDF values and color values associated with the sampling points of the associated with the one or more features.

In some aspects, generating the 3D representation of the object based on the first data and features from the generic model includes determining voxel volume data for voxels of the 3D representation, the voxel volume data corresponding to an estimated shape of the object based on the surfaces of the object.

In some aspects, the presentation of the 3D representation of the object (e.g., a preview) is based on determining a 3D mesh of the object from the voxel volume data for the 3D representation, wherein the 3D mesh of the object is generated based on determining signed distance values (SDVs) of voxel corners for the voxels of the 3D representation, the SDVs representing distances to surfaces of the object.

In some aspects, generating the first data, generating the 3D representation, and presenting the 3D representation of the object are performed on the device via a preview model that is trained based on a pre-trained model, wherein the pre-trained model is trained utilizing a plurality of training objects that include at least one of different types of objects, different shapes, different colors, and different textures. In some aspects, the pre-trained model is trained based on at least one of geometric constraints and photometric constraints.

In some aspects, generating the first data is based on a pose of the device. In some aspects, prior to generating the first data, the method includes identifying a subset of the image data corresponding to the object based on sensor data.

In some aspects, presenting the 3D representation of the object is based on depth data. In some aspects, presenting the 3D representation of the object is based on determining a subset of the plurality of 3D volumes. In some aspects, the subset of the plurality of 3D volumes is determined based on identifying a likelihood that each of the 3D volumes is at least partially occupied by a portion of the object.

In some aspects, the image data is obtained during movement of the device, wherein the movement of the device includes moving the device around the object to capture images from different perspectives of the object. In some aspects, the device includes a user interface, wherein during movement of the device, the user interface displays a view of the physical environment including the object and the presentation of the preview of the 3D representation of the object. In some aspects, the image data includes depth data that is obtained using one or more depth cameras, wherein the depth data includes pixel depth values from a viewpoint and a sensor position.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment, in accordance with some implementations.

FIG. 2 illustrates a view of a device that includes a preview of a 3D representation of an object based on extracting feature volumes, in accordance with some implementations.

FIG. 3 illustrates an example preprocessing of image data before generating a 3D preview of a 3D representation of an object based on extracting feature volumes, in accordance with some implementations.

FIG. 4 is a system flow diagram of an example generation of a preview of 3D representation of an object based on image and SDF data of a voxel representation of the object, in accordance with some implementations.

FIG. 5 illustrates extracting example data values of an area of a voxel representation of an object, in accordance with some implementations.

FIG. 6 illustrates an example of training a generalized signed distance function (SDF) model to determine SDF values (SDFs) of an area of depth data, in accordance with some implementations.

FIG. 7 illustrates an example of extraction of feature volumes for different keyframes based on different positions of a camera with respect to an object, in accordance with some implementations.

FIG. 8 illustrates an example surface extraction technique of feature volumes for a keyframe based on parallel processing, in accordance with some implementations.

FIG. 9 illustrates a timing diagram for implementing a process for generating a preview of a three-dimensional (3D) representation of an object based on extracting feature volumes, in accordance with some implementations.

FIG. 10 is a flowchart illustrating a method for generating a preview of a 3D representation of an object based on extracting feature volumes, in accordance with some implementations.

FIG. 11 is a block diagram of an electronic device of, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and Figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

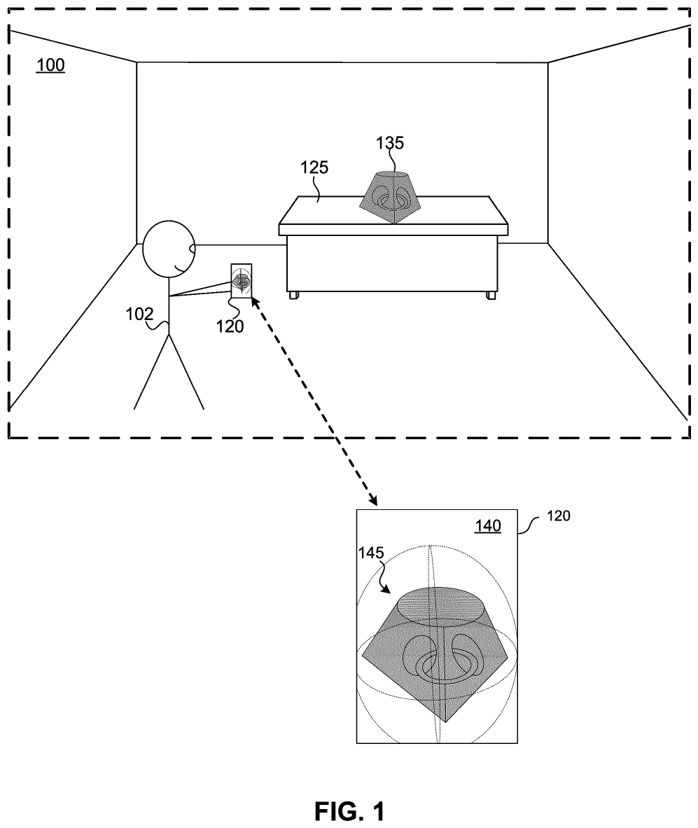

FIG. 1 illustrates an exemplary electronic device 120 operating in a physical environment 100. In this example of FIG. 1, the physical environment 100 is a room that includes a desk 125 a gadget 135 on top of the desk (e.g., a uniquely shaped toy, such as an activity cube). The electronic device 120 includes one or more cameras, microphones, depth sensors, or other sensors that can be used to capture information about and evaluate the physical environment 100 and the objects within it, as well as information about the user 102 of the electronic device 120.

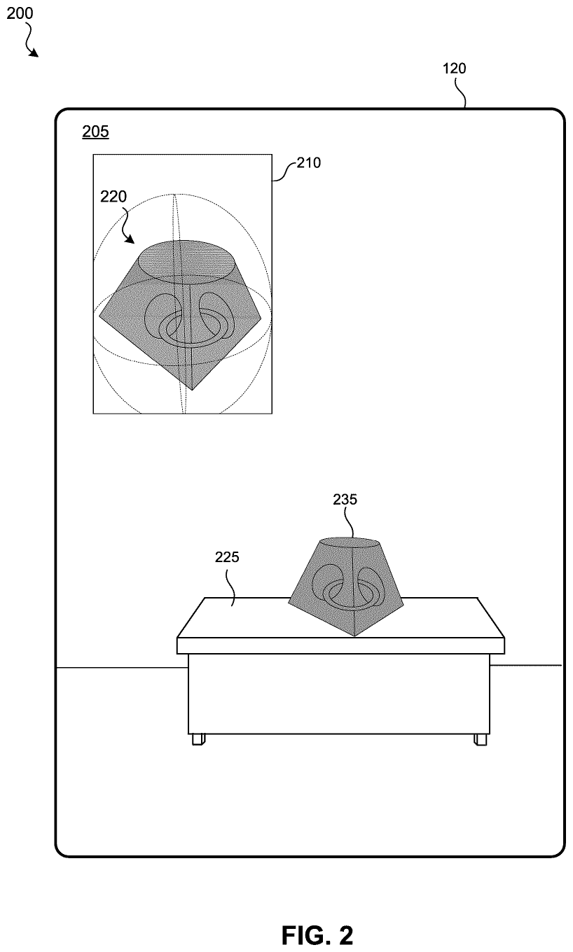

FIG. 1 illustrates a user (e.g., user 102) scanning an object (e.g., gadget 135) in order to create a 3D model of the scanned object. Moreover, FIG. 1 provides a view 140 on the device 120 of a 3D preview window that includes a 3D representation 145 (e.g., a 3D point cloud representation of the gadget 135). For example, the user 102 may be scanning the gadget 135, and during the scan, the system using generalized SDF model techniques further described herein, continuously provides and updates the 3D representation 145 within the 3D preview window, as further discussed in FIG. 2. For example, the system and methods described herein may provide a 3D preview (e.g., a view of a voxel model) during object scanning using a process (e.g., machine learning) that extracts 3D object geometry from color (e.g., RGB) images from different camera poses. The 3D geometry extraction from dense color image data is more accurate than using only sparse depth data-based modeling with respect to showing thin/unique structures (e.g., a leaf). In other words, the intent is to perform an on-device inference of a high quality preview (e.g., 3D point cloud or voxel) representation of an object using high resolution RGB and depth data as input into a continuous signed distance function (SDF) model (e.g., a learned continuous SDF representation of a class of shapes that enables high quality shape representation, interpolation, and completion from partial and noisy 3D input data).

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may have direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

FIG. 2 illustrates a view of a device that includes a preview of a 3D representation of an object based on extracting feature volumes, in accordance with some implementations. In particular, FIG. 2 illustrates an exemplary environment 200 of an exemplary view 205 of a physical environment 100 provided by an electronic device 120. The view 205 (e.g., a live view) includes representation 225 of desk 125 and representation 235 of gadget 135. Additionally, FIG. 2 provides a 3D preview window 210 that includes a 3D representation 220 (e.g., a 3D point cloud representation of the gadget 135). For example, as illustrated in FIG. 2, the user 102 may be scanning the gadget 135, and during the scan, the system using the generalized SDF model techniques described herein, continuously provides and updates the 3D representation 220 within the 3D preview window 210.

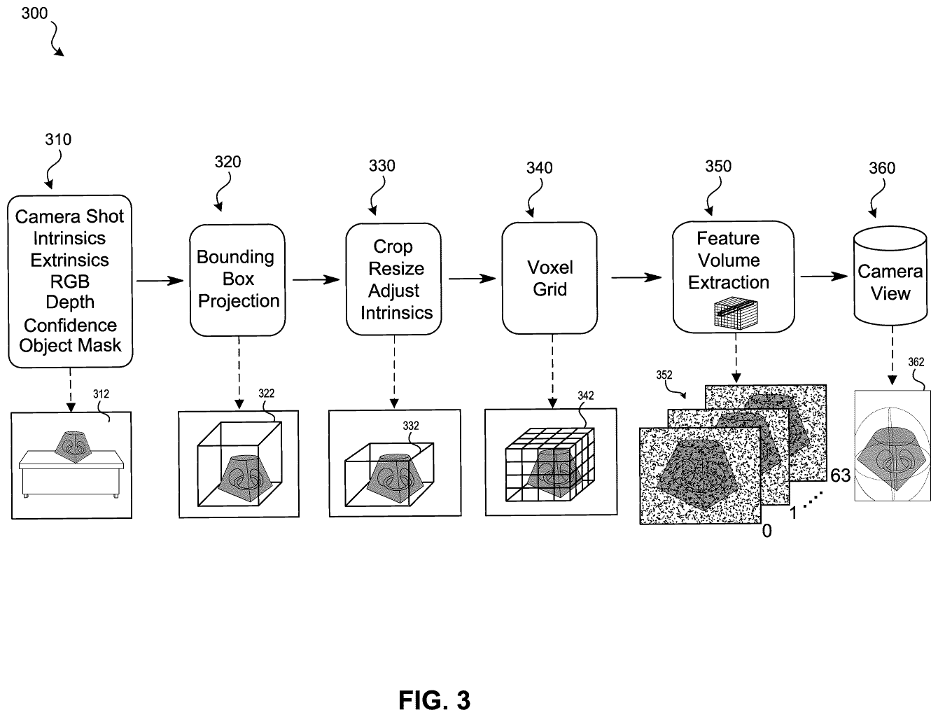

FIG. 3 illustrates an example environment 300 for preprocessing of image data before generating a 3D preview of a 3D representation of an object based on extracting feature volumes, in accordance with some implementations. In an exemplary implementation, at step 310, a frame of image date (e.g., a camera shot) is acquired, and the data obtained from the frame of image data 312 may include intrinsics (e.g., focal length, aperture, resolution, scale factor, principal point, skew, etc.), extrinsics (e.g., world to camera coordinate transformation based on camera pose information), RGB information, depth data, and the like. Additionally, analysis of the image data may be performed that may include a confidence analysis and/or an object mask may be applied as part of an object detection algorithm (e.g., to identify an object, such as gadget 135, may be present within a current viewpoint).

At step 320, a bounding box 322 may be initially projected onto the detected object to limit the voxel analysis to be performed. After an initial bounding box 322 is determined, at step 330, a refined bounding box 332 may be determined by cropping, resizing, and adjusting the intrinsics of the image data. The refined bounding box 332 may then further limit an amount of analysis to be performed in a subsequent step. At step 340, a voxel grid 342 is generated based on the refined bounding box 332. At step 350, the feature volumes 352 are extracted based on the voxel grid 342 in order to project a multiview feature matrix. A multiview feature matrix may then be used by a pre-trained generalized SDF model to send corresponding color and density values to a renderer. At stage 360, a camera view may then include a rendering of a 3D representation of the object from the image data at step 310 in a 3D preview window 362 (e.g., 3D preview window 210 that includes a 3D representation 220 of FIG. 2).

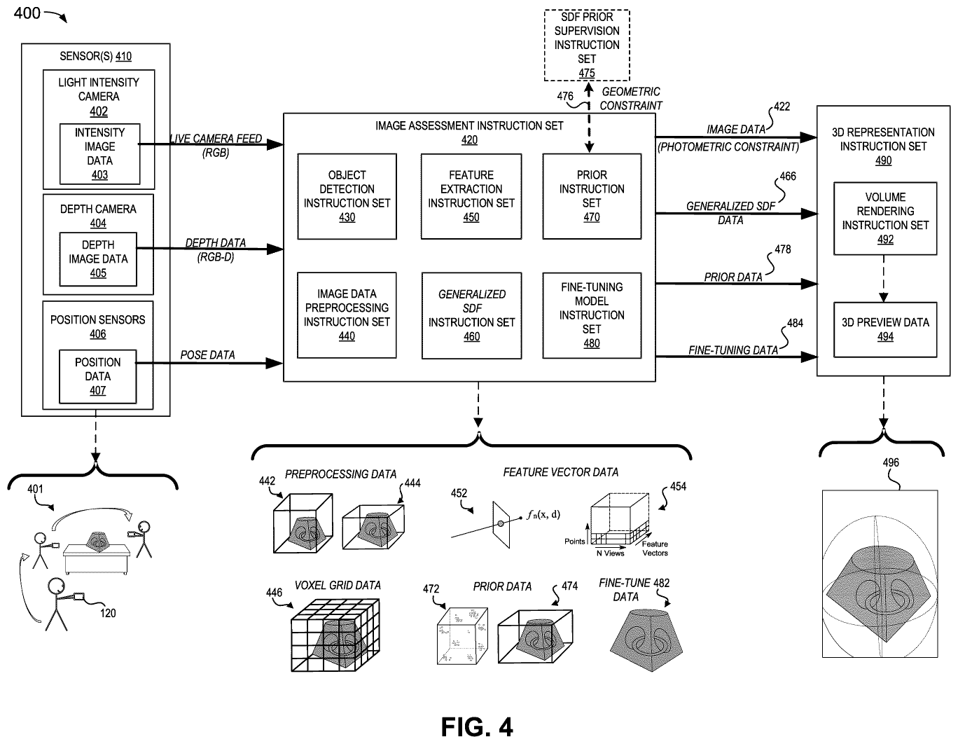

FIG. 4 is a system flow diagram of an example environment 400 in which a system can generate a preview of 3D representation of an object based on image and SDF data of a voxel representation of the object, according to some implementations. In some implementations, the system flow of the example environment 400 is performed on a device (e.g., device 120 of FIG. 1), such as a mobile device, desktop, laptop, or server device. The images of the example environment 400 can be displayed on a device (e.g., device 120 of FIG. 1) that has a screen for displaying images and/or a screen for viewing stereoscopic images such as a head-mounted device (HMD). In some implementations, the system flow of the example environment 400 is performed on processing logic, including hardware, firmware, software, or a combination thereof. In some implementations, the system flow of the example environment 400 is performed on a processor executing code stored in a non-transitory computer-readable medium (e.g., a memory).

The system flow of the example environment 400 acquires from sensors (e.g., sensors 410) light intensity image data 403 (e.g., live camera feed such as RGB from light intensity camera 402), depth image data 405 (e.g., depth image data such as RGB-D from depth camera 404), and other sources of physical environment information (e.g., camera positioning information 407 such as position and orientation data from position sensors 406) of a physical environment (e.g., the physical environment 100 of FIG. 1), assesses the images and determines feature extraction data (e.g., SDFs, density, color values, etc.) during acquisition of the images (e.g., the image assessment instruction set 420), and generates 3D preview data 494 of the object(s) for one or more frames from the image assessment data (e.g., the 3D representation instruction set 490).

In an example implementation, the environment 400 includes an image composition pipeline that acquires or obtains data (e.g., image data from image source(s) such as sensors 410) for the physical environment. Example environment 400 is an example of acquiring image sensor data (e.g., light intensity data, depth data, and position information) for a plurality of image frames. The image source(s) may include a depth camera 404 that acquires depth data 405 of the physical environment, a light intensity camera 402 (e.g., RGB camera) that acquires light intensity image data 403 (e.g., a sequence of RGB image frames), and position sensors 406 to acquire positioning information. For the positioning information 407, some implementations include a visual inertial odometry (VIO) system to determine equivalent odometry information using sequential camera images (e.g., light intensity data 403) to estimate the distance traveled. Alternatively, some implementations of the present disclosure may include a SLAM system (e.g., position sensors 406). The SLAM system may include a multidimensional (e.g., 3D) laser scanning and range measuring system that is GPS-independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In an example implementation, the environment 400 includes an image assessment instruction set 420 that is configured with instructions executable by a processor to obtain sensor data (e.g., image data such as light intensity data, depth data, camera position information, etc.) and determine image assessment subset of sensor data (e.g., image data 422), generalized SDF data 466, prior data 478 (e.g., geometric and/or photometric constraints), fine-tuning data 484, and other data using one or more of the techniques disclosed herein.

In some implementations, the image assessment instruction set 420 includes an object detection instruction set 430 that is configured with instructions executable by a processor to analyze the image information and identify objects within the image data. For example, the object detection instruction set 430 of the image assessment instruction set 420 analyzes RGB images from a light intensity camera 402 with a sparse depth map from a depth camera 404 (e.g., time-of-flight sensor) and other sources of physical environment information (e.g., camera positioning information 407 from a camera's SLAM system, VIO, or the like such as position sensors 406) to identify objects (e.g., furniture, appliances, statues, etc.) in the sequence of light intensity images. In some implementations, the object detection instruction set 430 uses machine learning for object identification. In some implementations, the machine learning model is a neural network (e.g., an artificial neural network), decision tree, support vector machine, Bayesian network, or the like. For example, the object detection instruction set 430 uses an object detection neural network instruction set to identify objects and/or an object classification neural network to classify each type of object.

In some implementations, the image assessment instruction set 420 includes an image data preprocessing instruction set 440 that is configured with instructions executable by a processor to analyze the image information and objection detection data and try to truncate the amount of data before feature extraction (e.g., bounding box projection, cropping and resizing, and updating intrinsics). For example, the image data preprocessing instruction set 440 of the image assessment instruction set 420 analyzes RGB images from a light intensity camera 402 with a depth map from a depth camera 404 (e.g., time-of-flight sensor) and other sources of physical environment information (e.g., camera positioning information 407 from a camera's SLAM system, VIO, or the like such as position sensors 406) to determine a bounding box 442 and a refined bounding box 444 corresponding to an object. Additionally, the image data preprocessing instruction set 440 can determine a voxel grid data 446 for the refined bounding box before sending the truncated/refined data set to the feature extraction instruction set 450.

In some implementations, the image assessment instruction set 420 includes a feature extraction instruction set 450 to extract features of the voxel grid and attentively aggregate the deep feature set using one or more of the techniques disclosed herein. For example, as illustrated in FIG. 3, the feature extraction instruction set 450 may determine feature vectors 452 (e.g., processing batches in parallel on a GPU), and aggregate and fuse the data to create a multiview feature matrix 454 to be sent to an inference network (e.g., generalized SDF instruction set 460).

In some implementations, the image assessment instruction set 420 includes a generalized SDF instruction set 460 to generate generalized SDF data 466 associated with the extracted feature data from the feature extraction instruction set 450 (multiview feature matrix 454) using one or more of the techniques disclosed herein. For example, generalized SDF instruction set 460 may determine SDF values and color values for each sampling point and convert the SDF to density values to be used to render a 3D representation (e.g., a 3D point cloud).

In some implementations, the image assessment instruction set 420 includes a prior instruction set 470 to incorporate prior data 478 during the process using one or more of the techniques disclosed herein. For example, prior instruction set 470 may determine and incorporate prior data as a prior for generating the generalized neural field, such as using live depth data (e.g., point cloud 472), or a previous refined bounding box 474, as a prior. Additionally, prior instruction set 470 processes the geometric constraints 476 from the SDF prior supervision instruction set 475 and sends the geometric constraints 476 to the generalized SDF instruction set 460 for generating a subsequent frame of volume rendering data (e.g., plane constraints to improve the reconstruction quality of low-textured regions, make large planes keep parallel or vertical to the wall or floor, and the like). Additionally, prior instruction set 470 processes photometric constraints associated with input RGB frames (keyframes) such as lighting and color issues, etc. that be incorporated or accounted for when generating a rendering (3D representation) for the 3D preview.

In some implementations, the image assessment instruction set 420 includes a fine-tuning instruction set 480 to generate fine-tuning data 484 for refining iterations of the generalized SDF data using one or more of the techniques disclosed herein. For example, a higher quality 3D preview may be generated based on the fine-tune representation 482. Some example techniques for generating fine-tuning data 484 may include binary thresholding to keep or prune each determined voxel. Additionally, or alternative, space carving techniques may be used to limit the voxel grid size based on occupancy values to improve speed and efficiency. For example, an exemplary space carving technique initializes an occupancy voxel grid to all zeros, projects voxels on an object mask, determines if voxels are inside/outside mask, increments visibility score of inside mask voxels, prunes voxels with low visibility score, and runs inference (e.g., executes the generalized SDF instruction set 460) only on the remaining voxels. In other words, by reducing the number of voxels, the preview of the 3D representation of the object may be generated faster and more efficiently.

In an example implementation, the environment 400 further includes a 3D representation instruction set 490 that is configured with instructions executable by a processor to, at a volume rending instruction set 492, obtain the image assessment data (e.g., image data 422) from the image assessment instruction set 420, the generalized SDF data 466, prior data 478, and the fine-tuning data 484, and generate 3D preview data 494 (e.g., a dense point cloud reconstruction) using one or more techniques. For example, the 3D representation instruction set 490 generates a 3D mesh 496 (e.g., a 3D preview) for one or more points of view of the unique object (e.g., gadget 135 of FIG. 1).

The generated 3D model data (e.g., 3D preview data 494) could be 3D mesh representation representing the surfaces of the object (e.g., a uniquely shaped toy) in a 3D environment using a 3D point cloud. In some implementations, the 3D preview data 494 is a 3D reconstruction mesh that is generated using a meshing algorithm based on depth information detected in the physical environment that is integrated (e.g., fused) to recreate the physical environment. A meshing algorithm (e.g., a dual marching cubes meshing algorithm, a poisson meshing algorithm, a tetrahedral meshing algorithm, or the like) can be used to generate a mesh representing a room (e.g., physical environment 100) and/or object(s) within a room (e.g., gadget 135, desk 125, etc.). In some implementations, for 3D reconstructions using a mesh, to efficiently reduce the amount of memory used in the reconstruction process, a voxel hashing approach is used in which 3D space is divided into voxel blocks, referenced by a hash table using their 3D positions as keys. The voxel blocks are only constructed around object surfaces, thus freeing up memory that would otherwise have been used to store empty space. The voxel hashing approach is also faster than competing approaches at that time, such as octree-based methods. In addition, it supports streaming of data between the GPU, where memory is often limited, and the CPU, where memory is more abundant.

In some implementations, the generated 3D preview data 494 (e.g., 3D model data) of the gadget 135 is determined based on refined images, where the refined images are determined based on at least one of 3D keypoint interpolation, densification of 3D sparse point clouds associated with the images, a 2D mask corresponding to the object to remove background image pixels of the images, and/or a 3D bounding box constraint corresponding to the object to remove background image pixels of the images. In some implementations, the 3D keypoint interpolation, the densification of the 3D sparse point clouds, the 2D mask, and the 3D bounding box constraint are based on the coordinate system (e.g., pose tracking data) of the object.

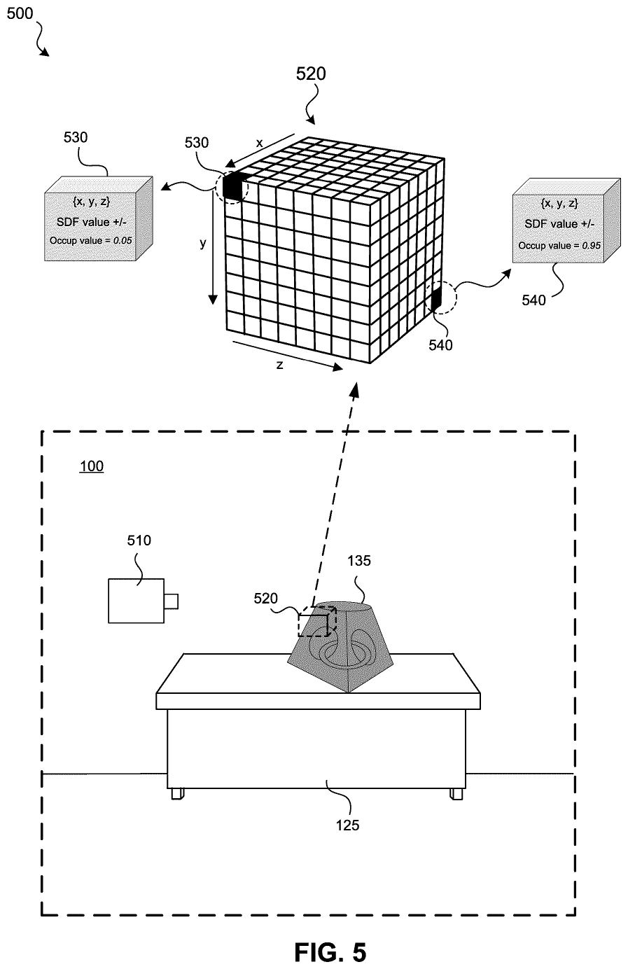

FIG. 5 illustrates extracting example data values of an area of a voxel representation of an object, in accordance with some implementations. In particular, FIG. 5 illustrates determining signed distance function values (SDFs) of an area of depth data in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 500 includes a sensor 510 of a device (e.g., a camera/sensor of device 120), and a uniquely shaped object (e.g., gadget 135) on top of the desk 125. Moreover, FIG. 5 illustrates an example operating environment 500 of the physical environment 100 of FIG. 1 while determining data values of a voxel area 520 of depth data of an object (e.g., gadget 135) from a first viewpoint in accordance with some implementations. For example, sensor 510 captures image and/or depth data of an object(s) (e.g., gadget 135 on top of desk 125) from a first viewpoint.

The example environment 500 further includes an 8x8x8 orthogonal (uniform) voxel grid 520. The voxel grid 520 represents all the information in a volume by a fixed 3D grid of voxels that is pre-allocated in memory based on the images from one or more viewpoints from sensor 510. Each voxel (e.g., voxel 530, 540) may include the global coordinates (x,y,z) and the SDF values from the surface of the gadget 135 in order to extract feature volume data (e.g., feature vectors), as further discussed herein. In some implementations, a signed distance value may be stored if a voxel is within the truncation threshold or ignored for those voxels outside of the respective truncation threshold. For each voxel (e.g., voxel 530, 540), the information may be stored in buckets based on different parameters (e.g., stored information may include the world coordinates (x,y,z), SDF values, and/or an occupancy value). In some implementations, the information stored in the buckets may be further based on color information in combination with the world coordinates (x,y,z), SDF values, and occupancy values.

In exemplary implementations, systems and methods described herein may determine occupancy data for each voxel (e.g., voxel 530, 540) of a 3D voxel representation (e.g., voxel grid 520), where the occupancy data corresponds to whether the voxels are occupied by an object (e.g., gadget 135). For example, determining occupancy data for the voxels (e.g., voxel 530, 540) may include identifying likelihoods that the voxels are occupied (e.g., by an object, such as a surface or edge of the desk 125) rather than being empty space, between 0 and 1, where “1” being 100% confident the voxel is being occupied, and close to 0 means mostly empty space within the voxel. For example, as illustrated in FIG. 5, the voxel 540 is determined to very likely include a surface of the object (e.g., gadget 135) and the determined occupancy data is 0.95 is stored therein (e.g., 95% confident the voxel is being occupied), and voxel 530 is determined to not likely include a surface of the object and the determined occupancy data is 0.05 is stored therein (e.g., 95% confident the voxel is mostly empty space).

In some implementations, the 3D volumetric data may include distributed voxel addresses, and the stored 3D positions may be used as keys for hash table entries to provide the (x,y,z) coordinates and the associated SDF data and occupancy data to generate memory addresses storing voxel information. For instance, in example 3D volumetric data, each bit may be unique, and the (x,y,z) coordinates of each voxel, may be unique. In one example implementation, an algorithm implemented in a system may take advantage of the unique voxel locations and associated SDF data and occupancy data in example 3D volumetric data to provide an addressing scheme which minimizes unordered or excess hash table entries.

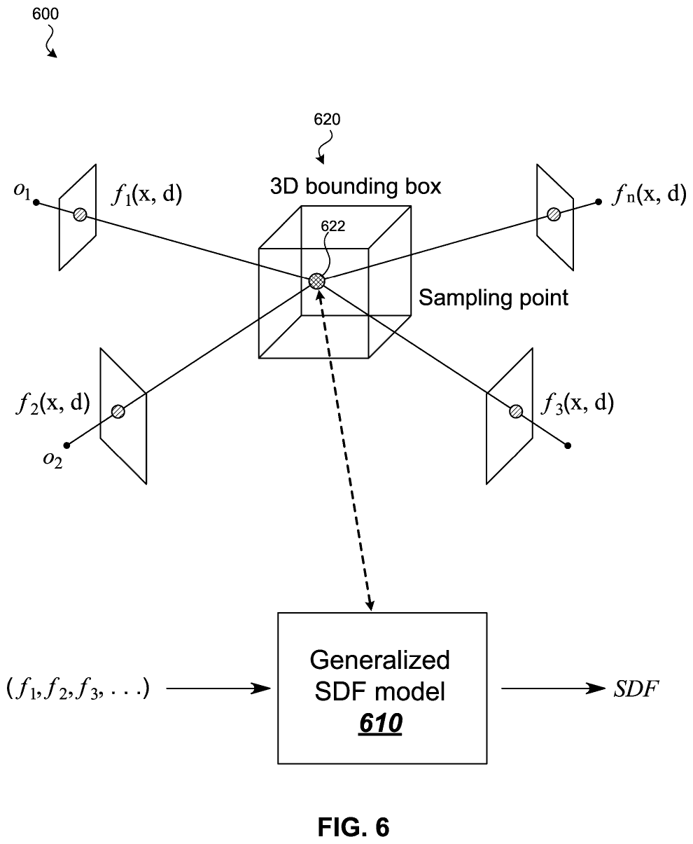

FIG. 6 illustrates an example environment 600 of training a generalized signed distance function (SDF) model to determine SDF values (SDFs) of an area of depth data, in accordance with some implementations. For example, the generalized SDF model 610 may be a learned machine learning model that is trained to determine continuous SDF representations of shapes that enables high quality shape representation, interpolation, and completion from partial and noisy 3D input data offline. The idea is to determine the SDF values without having to classify the surface of shapes of the objects based on previously known shapes. In particular, as illustrated in FIG. 6, a given sampling point 622 within a bounding box 620 (e.g., a voxel cube) coordinate vectors can be determined (e.g., f₁(x,d), f₂(x,d), f₃(x,d), fₙ(x,d), etc.). Then the “pre-trained” generalized SDF model 610 can then be used for live RGB and depth data (e.g. on-device inference) to extrapolate and convert the coordinate vectors (f₁, f₂, f₃, . . . ) to feature space vectors (SDFs). The feature space vectors (SDFs) may then be utilized to be agnostic and generalizable to objects of different types, shapes, colors, and textures (e.g., shape agnostic).

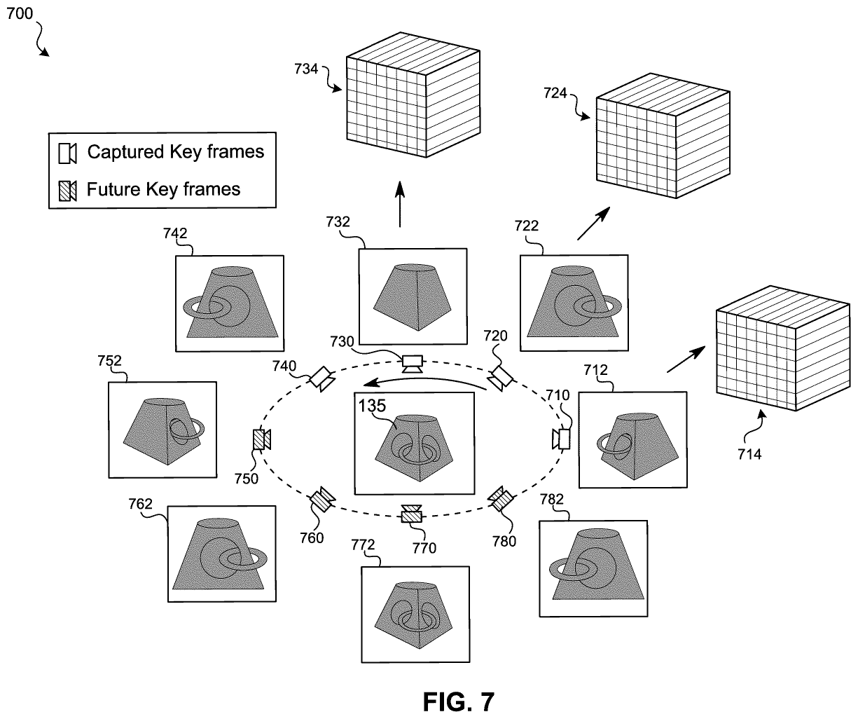

FIG. 7 illustrates an example environment 700 of extraction of feature volumes for different keyframes based on different positions of a camera with respect to an object, in accordance with some implementations. In this example, the example environment 700 illustrates a live scanning process and capturing eight keyframes 710, 720, 730, 740, 750, 760, 770, 780 of image data 712, 722, 732, 742, 752, 762, 772, 782, respectively. For example, eight different camera views are captured as a user walks around the gadget 135, where each keyframe is a different field of view and perspective relative to the gadget 135, the target object (e.g., a toy on a table). For each captured keyframe, a generalized SDF model (e.g., generalized SDF model 610) can then extrapolate feature volume data (e.g., feature volume 714 for keyframe 710, feature volume 724 for keyframe 720, feature volume 734 for keyframe 730, etc.).

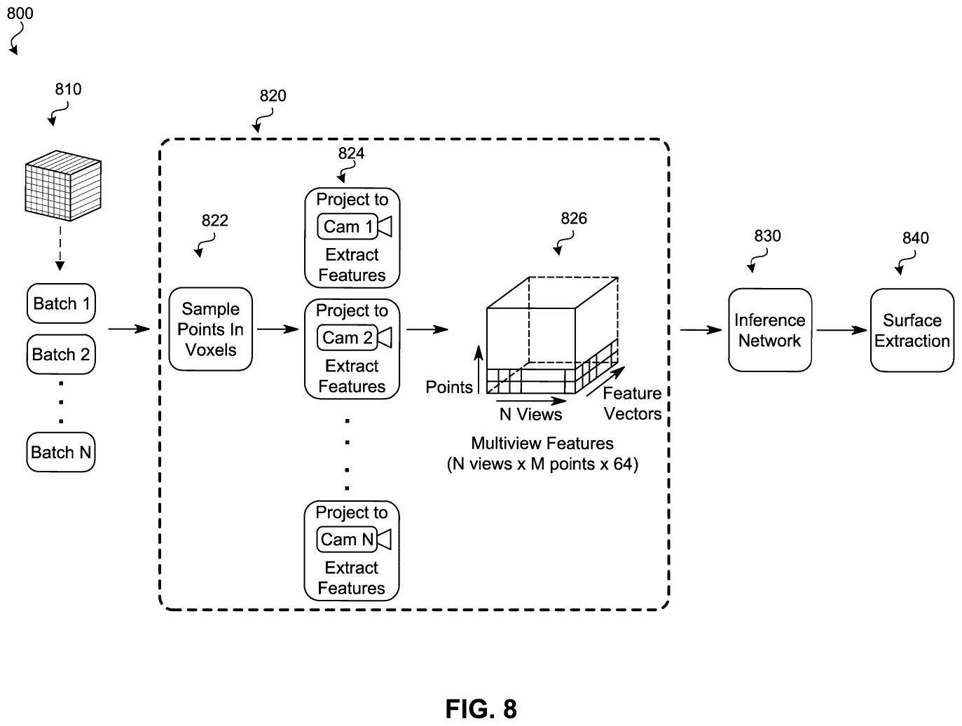

FIG. 8 illustrates an example environment 800 for a surface extraction technique of feature volumes for a keyframe based on parallel processing, in accordance with some implementations. In an exemplary implementation, at step 810, an example voxel grid may be divided into a series of batches, and for each batch, sent to a command buffer of a processing unit at step 820, such as a graphics processing unit (GPU). The processing unit at step 820 can then process each voxel batch in parallel as part of a feature extractor network. For example, at step 822, sample points in voxels are determined (e.g., sample point 622 in bounding box 620 of FIG. 6). At step 824, feature vectors are extracted for different projected viewpoints (e.g., projections to Cam 1, Cam 2, . . . . Cam N, etc.). At step 826, the feature vectors, views, and points, are compiled for the voxel grid to project a multiview feature matrix (e.g., N views×M points×64). In some implementations, a feedforward neural module and a dedicated training algorithm may be used to attentively aggregate the deep feature set for the multi-view 3D reconstruction to automatically learn to aggregate each element of input features. The multiview feature matrix may then be processed by an inference network at step 830 in order to infer corresponding density and color values for the multiview feature matrix. For example, a radiance field network may be used for an on-device inference network based on a view aggregator and an implicit field to determine the density field and color field. Then at step 840, the density and color values are projected for a surface extraction to determine density and color surface point values for a rendering of each determined surface point.

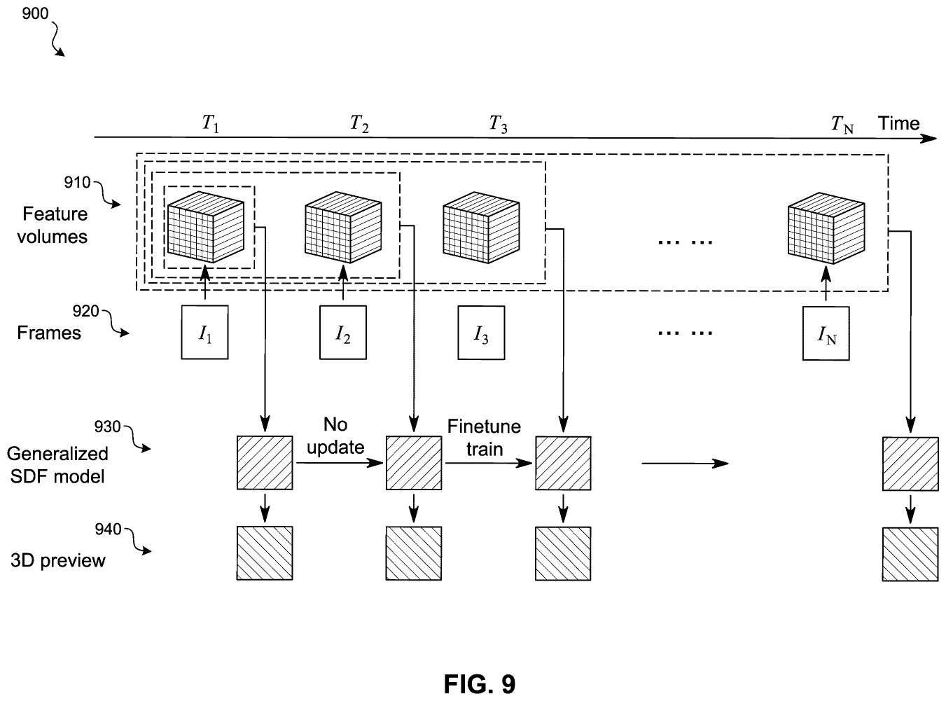

FIG. 9 illustrates a timing diagram 900 for implementing a process for generating a preview of a three-dimensional (3D) representation of an object based on extracting feature volumes, in accordance with some implementations. In particular, the process flow for timing diagram 900 utilizes a pre-trained generalized SDF model (e.g., generalized SDF model 610) for each frame or key-frame of image data to generate a 3D preview. For example, at time T₁, a first keyframe I₁ of the frame data 920 is analyzed at a feature volume stage 910 to project each point to scanned key frames and extract feature vectors from each point. The feature vectors are then aggregated by a view aggregator to fuse the feature vectors which are sent to the pre-trained generalized SDF model 930. The pre-trained generalized SDF model 930 determines SDF and color values for each sampling point, converts the SDFs to density values, and sends that information to a renderer to project the 3D preview of a 3D point cloud or voxel representation at the 3D preview stage 940. Similarly, at time T₂, a second keyframe I₂ of the frame data 920 is analyzed to produce an additional frame of the 3D preview, at time T₃, a third keyframe I₃ of the frame data 920 is analyzed to produce more frames of the 3D preview through time T_{N}. Additionally, in some implementations, as additional keyframes of image data are analyzed, additional processing steps (e.g., fine-tuning) may be utilized to increase the quality of the 3D preview. The fine-tuning implementations of using live depth data (e.g., as a prior), binary thresholding to keep or prune each voxel, and/or space carving to improve speed and efficiency will be further discussed herein.

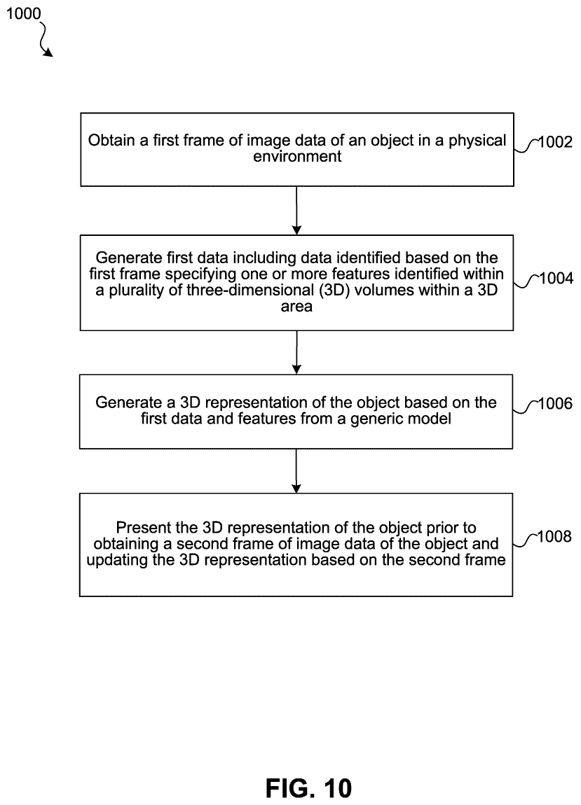

FIG. 10 is a flowchart illustrating a method 1000 for generating a preview of a 3D representation of an object based on extracting feature volumes, in accordance with some implementations. In some implementations, a device such as electronic device 120 performs method 1000. In some implementations, method 1000 is performed on a mobile device, desktop, laptop, HMD, or server device. The method 1000 is performed by processing logic, including hardware, firmware, software, or a combination thereof. In some implementations, the method 1000 is performed on a processor executing code stored in a non-transitory computer-readable medium (e.g., a memory). In some implementations, the device performing the method 1000 includes a processor and one or more sensors.

At block 1002, the method 1000 obtains a first frame of image data of an object in a physical environment. For example, during a scanning process as illustrated in FIG. 4, one or more frames may be acquired as the user moves the device around the object to capture images of the object from different sides/viewpoints.

In some implementations, the image data may include image data, depth data, and camera pose data of an object, including images of the physical environment captured via a camera on the device. For example, a user may move the device around an object to capture images of the object from different sides/viewpoints. In some implementations, the sensor data may include depth data and motion sensor data. In some implementations, the image data includes depth data that is obtained using one or more depth cameras, where the depth data includes pixel depth values from a viewpoint and a sensor position.

In some implementations, during movement of the device, a user interface may display the acquired environment that includes the object and provide a user interface element. For example, a user interface element (e.g., an extended reality image, such as a 3D arrow or a specifically oriented circle overlaid on a live video stream) can show a user additional angles and/or perspectives to acquire the object.

In some implementations, the sensor data signal may include RGB data, lidar-based depth data, and/or depth data. For example, sensors on a device (e.g., camera's, IMU, etc. on device 120) can capture information about the position, location, motion, pose, etc., of an object, including tracking positions of the object. The depth data can include pixel depth values from a viewpoint and sensor position and orientation data. In some implementations, the depth data is obtained using one or more depth cameras. For example, the one or more depth cameras can acquire depth based on structured light (SL), passive stereo (PS), active stereo (AS), time-of-flight (ToF), and the like. Various techniques may be applied to acquire depth image data to assign each portion (e.g., at a pixel level) of the image. For example, voxel data (e.g., a raster graphic on a 3D grid, with the values of length, width, and depth) may also contain multiple scalar values such as opacity, color, and density. In some implementations, depth data is obtained from sensors or 3D models of the content of an image. Some or all of the content of an image can be based on a real environment, for example, depicting the physical environment 100 around the device 120. Image sensors may acquire images of the physical environment 100 for inclusion in the image and depth information about the physical environment 100. In some implementations, a depth sensor on the device 120 determines depth values for voxels that are determined based on images acquired by an image sensor on the device 120.

In some implementations, a sensor data signal for the image data includes multiple sensor data signals. For example, one of the multiple sensor data signals may be an image signal, one of the multiple sensor data signals may be a depth signal (e.g., a structured light, a time-of-flight, or the like), one of the multiple sensor data signals may be a device motion signal (e.g., an accelerometer, an inertial measurement unit (IMU) or other tracking systems), and the like. In some implementations, the sensor data signal includes at least one of light intensity image data, depth data, user interface position data, and motion data, or a combination thereof.

At block 1004, the method 1000 generates first data including data identified based on the first frame specifying one or more features identified within a plurality of 3D volumes (e.g., small cubical regions, voxels, and the like) within a 3D area (e.g., a larger cubical region). For example, the first data extracts a 3D feature volume for each frame of a first set of frames (e.g., the frames up to the currently captured frame).

In some implementations, the 3D volume is a 3D voxel representation of the object that is generated based on the image data. In some implementations, generating the 3D voxel representation of the object includes generating a 3D point cloud of the object based on the sensor data, and generating the 3D voxel representation based on the 3D point cloud. For example, generating a 3D voxel representation may involve generating a 3D point cloud of the object (e.g., 3D point cloud 472), and then generating a voxel representation based on the 3D point cloud.

In some implementations, generating the first data is based on a pose of the device. For example, position data 407 of the device capturing the images may be used as a further prior constraint when processing the image data during movement of the device.

At block 1006, the method 1000 generates a 3D representation of the object based on the first data and features from a generic model. For example, the 3D representation of the object is based on matched features from a generic model, such as a generalized SDF model discussed herein.

In some implementations, generating the 3D representation of the object based on the first data and features from the generic model includes generating a 3D feature matrix based on fusing feature vectors of sampling points associated with the one or more features (e.g., view aggregator to fuse feature vectors), determining signed distance field (SDF) values and color values associated with the sampling points associated with the one or more features, and determining density and color values for surface data of the 3D representation based on the SDF values and color values associated with the sampling points of the associated with the one or more features. For example, the method 1000 may fuse feature volumes to generate a 3D feature matrix (e.g., aggregate), produce SDF values, and use SDF and color values for sampling points to produce density/color values from which surface data may be extracted.

In some implementations, generating the 3D representation of the object based on the first data and features from the generic model includes determining voxel volume data for voxels of the 3D representation, the voxel volume data corresponding to an estimated shape of the object based on the surfaces of the object. For example, determining voxel volume data (e.g., shape agnostic data corresponding to the object) for voxels of the 3D representation may involve sampling points in each voxel, projecting each point to scanned key frames and extract feature vectors from each of them, fusing feature vectors via view aggregator, applying the pre-trained generalized SDF model, determining SDF values and color value for each sampling point, and converting SDF to density values.

At block 1008, the method 1000 presents the 3D representation of the object prior to obtaining a second frame of image data of the object and updating the 3D representation based on the second frame. For example, images obtained following or during display of the preview for use in (a) updating the preview during the scan and/or (b) generation of a final/different 3D model that may be generated after the scanning is complete.

In some implementations, presenting the 3D representation occurs after obtaining a first frame of the first set of frames of image data and prior to obtaining a second frame of the first set of frames of image data of the object (e.g., a preview is initiated after starting the scanning process, i.e., after capturing a first frame). In other words, after one or two image frames, the 3D preview (e.g., 3D representation 220 in preview window 210 of FIG. 2) may be displayed on the device while the user is scanning the object for real-time feedback, and with higher quality because high resolution RGB images and depth data are obtained to generate high quality point clouds. In some implementations, the first set of frames and the second set of frames are part of a single capture process (e.g., a 3D object scanning process, a video).

In some implementations, generating the first data, generating the 3D representation, and presenting the 3D representation of the object are performed on the device via a preview model that is trained based on a pre-trained model that is trained utilizing a plurality of training objects that include at least one of different types of objects, different shapes, different colors, and different textures. For example, the “on-device” preview model is based on a shape agnostic pre-trained model, thus the extracting features for the first data, generating the 3D representation, and preview providing steps may be performed by a pre-trained model trained to work on objects of different types, shapes, colors, and textures (e.g., shape agnostic).

In some implementations, the pre-trained model is trained based on at least one of geometric constraints and photometric constraints. For example, a prior RGB image frame may include photometric constraints (e.g., lighting and/or coloring issues) that may be applied before rendering the final 3D representation, and a geometric constraint from an SDF prior (e.g., space carving) may be applied by the pre-trained model when applying the generalized neural field and determining the density and color values. In some implementations, a photometric constraint may include image intensity, perceptual information, structural information, signal to noise information, and the like. Moreover, in some implementations, a geometric constraint may include an epipolar geometry constraint (e.g., geometry of stereo vision), plane constraints, and the like, to improve the reconstruction quality of low-textured regions, make large planes keep parallel or vertical to the wall or floor, etc.

In some implementations, presenting the 3D representation of the object is based on depth data (e.g., live depth data). For example, the process/model may use live depth data (e.g., as a prior) to improve speed and efficiency. In some implementations, the preview of the 3D representation of the object is based on determining a subset of the plurality of 3D volumes. For example, the process/model may use space carving techniques to improve speed and efficiency. An exemplary space carving technique initializes an occupancy voxel grid to all zeros, projects voxels on an object mask, determines if voxels are inside/outside mask, increments visibility score of inside mask voxels, prunes voxels with low visibility score, and run inference only on the remaining voxels. In other words, by reducing the number of voxels, the preview of the 3D representation of the object may be generated faster and more efficiently.

In some implementations, the preview of the 3D representation of the object is based on determining a 3D mesh of the object from the voxel volume data for the 3D representation, wherein the 3D mesh of the object is generated based on determining signed distance values (SDVs) of voxel corners for the voxels of the 3D representation (e.g., signed distance field (SDF) values), the SDVs representing distances to surfaces (e.g., to a nearest surface) of the object. For example, the pre-trained generalized SDF model is able to quickly (e.g., ˜1 to 3 frames) convert a shape of an object with one iteration, trying to estimate the volume of object using depth data under supervised training in a pre-trained generalized SDF model in addition to an RGB image. Thus, in a few RGB images the method can predict an entire volume/shape with a goal to extract a high-resolution point cloud of the object in order to solve thin structure issues. For each subsequent iteration, this may involve a refining/fine tuning stage, e.g., running a binary thresholding technique to keep or prune each voxel.

In some implementations, prior to generating the first data, the method 1000 includes identifying a subset of the image data corresponding to the object based on sensor data. For example, the image data preprocessing instruction set 440 may generate a bounding box based on the RGB data, depth data, confidence level from the object detection instruction set 430. The image data preprocessing instruction set 440 may further crop and resize the bounding box in order to limit the amount of data needed to analyze by the feature extraction instruction set 450. This may involve object identification based on cropping/resizing a preliminary object model and its 3D keypoints, for example, using a 3D bounding box constraint to remove background pixels. In some implementations, identification may involve densification of a sparse depth cloud, keypoint interpolation, and/or exclusion of keypoints close to depth edges. In some implementations, identifying the foreground and background may be based on two neural radiance fields. For example, a foreground radiance field may be used for the object within the bounding box using an SDF field, and a background radiance field (e.g., NeRF density field) may be used for outside of the bounding box.

In some implementations, the first set of frames of image data are obtained during movement of the device, wherein the movement of the device includes moving the device around the object to capture images from different perspectives of the object. In some implementations, the device includes a user interface, where during movement of the device, the user interface displays a view of the physical environment (e.g., captured image data) including the object and the presentation of the preview of the 3D representation of the object (e.g., 3D representation 220 in preview window 210 of FIG. 2).

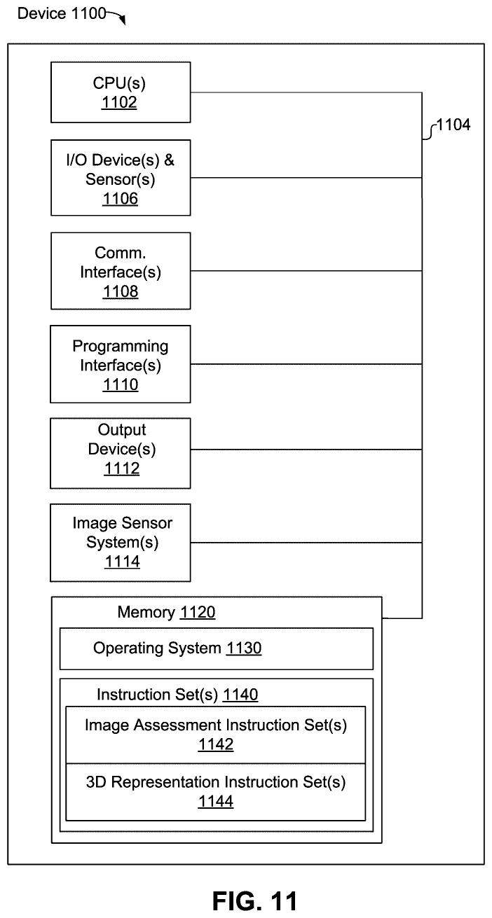

FIG. 11 is a block diagram of electronic device 1100. Device 1100 illustrates an exemplary device configuration for electronic device 120. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1100 includes one or more processing units 1102 (e.g., microprocessors, ASICs, FPGAs, GPUs, CPUs, processing cores, and/or the like), one or more input/output (I/O) devices and sensors 1106, one or more communication interfaces 1108 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1110, one or more output device(s) 1112, one or more interior and/or exterior facing image sensor systems 1114, a memory 1120, and one or more communication buses 1104 for interconnecting these and various other components.

In some implementations, the one or more communication buses 1104 include circuitry that interconnects and controls communications between system components. In some implementations, the one or more I/O devices and sensors 1106 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1112 include one or more displays configured to present a view of a 3D environment to the user. In some implementations, the one or more device(s) 1112 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1100 includes a single display. In another example, the device 1100 includes a display for each eye of the user.

In some implementations, the one or more output device(s) 1112 include one or more audio producing devices. In some implementations, the one or more output device(s) 1112 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1112 may additionally or alternatively be configured to generate haptics.

In some implementations, the one or more image sensor systems 1114 are configured to obtain image data that corresponds to at least a portion of a physical environment. For example, the one or more image sensor systems 1114 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1114 further include illumination sources that emit light, such as a flash. In various implementations, the one or more image sensor systems 1114 further include an on-camera image signal processor (ISP) configured to execute a plurality of processing operations on the image data.

The memory 1120 includes high-speed random-access memory, such as DRAM, SRAM, DDR RAM, or other random-access solid-state memory devices. In some implementations, the memory 1120 includes non-volatile memory, such as one or more magnetic disk storage devices, optical disk storage devices, flash memory devices, or other non-volatile solid-state storage devices. The memory 1120 optionally includes one or more storage devices remotely located from the one or more processing units 1102. The memory 1120 includes a non-transitory computer readable storage medium.

In some implementations, the memory 1120 or the non-transitory computer readable storage medium of the memory 1120 stores an optional operating system 1130 and one or more instruction set(s) 1140. The operating system 1130 includes procedures for handling various basic system services and for performing hardware dependent tasks. In some implementations, the instruction set(s) 1140 include executable software defined by binary information stored in the form of an electrical charge. In some implementations, the instruction set(s) 1140 are software that is executable by the one or more processing units 1102 to carry out one or more of the techniques described herein.

The instruction set(s) 1140 includes an image assessment instruction set 1142 and a 3D representation instruction set 1144. The instruction set(s) 1140 may be embodied as a single software executable or multiple software executables.

The image assessment instruction set 1142 is configured with instructions executable by a processor to obtain sensor data (e.g., image data such as light intensity data, depth data, camera position information, etc.) and determine generalized SDF data, prior data, and/or fine-tuning data based on assessing the images with respect to an object based on images and tracked positions of a device during acquisition of the images using one or more of the techniques disclosed herein. For example, the image assessment instruction set 1142 analyzes RGB images from a light intensity camera with a depth map from a depth camera (e.g., time-of-flight sensor) and other sources of physical environment information (e.g., camera positioning information from a camera's SLAM system, VIO, or the like) to select a subset of information for 3D reconstruction. In some implementations, the image assessment instruction set 1142 includes separate instruction set(s), such as an object detection instruction set, an image data preprocessing instruction set, a feature extraction instruction set, a generalized SDF representation instruction set, a prior instruction set, and a fine-tuning instruction set, as discussed herein.

The 3D representation instruction set 1144 is configured with instructions executable by a processor to obtain the image data, SDF data, prior data, and/or fine-tuning data from the image assessment instruction set 1142 and generate a preview of a 3D model using one or more techniques disclosed herein. For example, the 3D representation instruction set 1144 generates a 3D model (e.g., a 3D mesh representation, a 3D point cloud, or the like) based on the analyzed image data, SDF data, prior data, and/or fine-tuning data.

Although the instruction set(s) 1140 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or conFIGs. the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a device having a processor:
obtaining a first frame of image data of an object in a physical environment;
generating first data comprising data identified based on the first frame specifying one or more features identified within a plurality of three-dimensional (3D) volumes within a 3D area;
generating a 3D representation of the object based on the first data and features from a generic model; and
presenting the 3D representation of the object, wherein presenting the 3D representation of the object occurs prior to obtaining a second frame of image data of the object and updating the 3D representation based on the second frame.

2. The method of claim 1, wherein presenting the 3D representation occurs after obtaining the first frame of image data and prior to obtaining the second frame of image data of the object.

3. The method of claim 1, wherein the first frame and the second frame are part of a single capture process.

4. The method of claim 1, wherein generating the 3D representation of the object based on the first data and features from the generic model comprises:
generating a 3D feature matrix based on fusing feature vectors of sampling points associated with the one or more features;
determining signed distance field (SDF) values and color values associated with the sampling points associated with the one or more features; and
determining density and color values for surface data of the 3D representation based on the SDF values and color values associated with the sampling points of the associated with the one or more features.

5. The method of claim 1, wherein generating the 3D representation of the object based on the first data and features from the generic model comprises determining voxel volume data for voxels of the 3D representation, the voxel volume data corresponding to an estimated shape of the object based on surfaces of the object.

6. The method of claim 5, wherein presenting the 3D representation of the object is based on determining a 3D mesh of the object from the voxel volume data for the 3D representation, wherein the 3D mesh of the object is generated based on determining signed distance values (SDVs) of voxel corners for the voxels of the 3D representation, the SDVs representing distances to surfaces of the object.

7. The method of claim 1, wherein generating the first data, generating the 3D representation, and presenting the 3D representation of the object are performed on the device via a preview model that is trained based on a pre-trained model, wherein the pre-trained model is trained utilizing a plurality of training objects that include at least one of different types of objects, different shapes, different colors, and different textures.

8. The method of claim 7, wherein the pre-trained model is trained based on at least one of geometric constraints and photometric constraints.

9. The method of claim 1, wherein generating the first data is based on a pose of the device.

10. The method of claim 1, wherein prior to generating the first data, the method comprises identifying a subset of the image data corresponding to the object based on sensor data.

11. The method of claim 1, wherein presenting the 3D representation of the object is based on depth data.

12. The method of claim 1, wherein presenting the 3D representation of the object is based on determining a subset of the plurality of 3D volumes.

13. The method of claim 1, wherein a subset of the plurality of 3D volumes is determined based on identifying a likelihood that each of the 3D volumes is at least partially occupied by a portion of the object.

14. The method of claim 1, wherein the image data is obtained during movement of the device, wherein the movement of the device comprises moving the device around the object to capture images from different perspectives of the object.

15. The method of claim 1, wherein the device comprises a user interface, wherein during movement of the device, the user interface displays a view of the physical environment including the object and the presentation of the 3D representation of the object.

16. The method of claim 1, wherein the image data comprises depth data that is obtained using one or more depth cameras, wherein the depth data comprises pixel depth values from a viewpoint and a sensor position.

17. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining a first frame of image data of an object in a physical environment;
generating first data comprising data identified based on the first frame specifying one or more features identified within a plurality of three-dimensional (3D) volumes within a 3D area;
generating a 3D representation of the object based on the first data and features from a generic model; and
presenting the 3D representation of the object, wherein presenting the 3D representation of the object occurs prior to obtaining a second frame of image data of the object and updating the 3D representation based on the second frame.

18. The device of claim 17, wherein presenting the 3D representation occurs after obtaining the first frame of image data and prior to obtaining the second frame of image data of the object.

19. The device of claim 17, wherein the first frame and the second frame are part of a single capture process.

20. A non-transitory computer-readable storage medium, storing program instructions executable on a device to perform operations comprising:
obtaining a first frame of image data of an object in a physical environment;
generating first data comprising data identified based on the first frame specifying one or more features identified within a plurality of three-dimensional (3D) volumes within a 3D area;
generating a 3D representation of the object based on the first data and features from a generic model; and
presenting the 3D representation of the object, wherein presenting the 3D representation of the object occurs prior to obtaining a second frame of image data of the object and updating the 3D representation based on the second frame.
